(19) United States
(12) Patent Application Publication
(10) Pub. No.: US 2008/0125891 A1
(43) Pub. Date: May 29, 2008

(54) AUDIO REPRODUCTION APPARATUS, AUDIO REPRODUCTION METHOD, PROGRAM, AND DATA MANAGEMENT METHOD

(75) Inventors: Tomoko SAKAKIBARA, Osaka (JP); Miki YAMASHITA, Osaka (JP); Naoki HORI, Kyoto (JP); Tomoko SOGABE, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/944,873

(22) Filed: Nov. 26, 2007

(30) Foreign Application Priority Data
Nov. 29, 2006 (JP) 2006-321767

(51) Int. Cl. G06F 7/00; G06F 17/30; G06F 17/00

(52) U.S. Cl. 700/94; 707/2; 707/E17.101

(57) ABSTRACT

An audio reproduction apparatus which reproduces an audio file including a header section and a data section, the header section containing position information for each unitary data, the data section containing a plurality of unitary data, said audio reproduction apparatus comprising: a reception unit operable to receive a special reproduction direction, the direction being given to repeat the partial reproduction and the partial skip of the data contained in the audio file in order; a calculation unit operable to calculate addresses of the plural pieces of data to be partially reproduced, by reading and interpreting the header of the audio file, when the special reproduction direction is received; a storage unit operable to store a special reproduction table in a memory, the special reproduction table containing the calculated addresses, the special reproduction table not containing addresses of data to be skipped; and a special reproduction unit operable to perform the special reproduction based on the addresses stored in the special reproduction table, wherein said special reproduction unit is operable to start the special reproduction, after completion of the calculation to an end of the data section by said calculation unit when the special reproduction is fast-forward reproduction, and is operable to start the special reproduction after completion of the calculation to a starting point of the data section by said calculation unit when the special reproduction is fast-reverse reproduction.

### BACKGROUND OF THE INVENTION

(1) Field of the Invention

The present invention relates to an audio reproduction apparatus, an audio reproduction method, a program, and a data management method which reproduce an audio file including a header section and a data section, the header section containing position information for each piece of data, the data section containing plural pieces of data.

(2) Description of the Related Art

For example, an audio file encoded by MPEG-4 AAC (Moving Picture Experts Group-4 Advanced Audio Coding) is roughly divided into the following two sections: a header section and a data section. The data section contains plural pieces of unitary data. The header section contains position information for each piece of unitary data. Each of the pieces of unitary data is called an “audio frame” or simply a “frame”.

In normal reproduction, a conventional audio reproduction apparatus, first reads the position information contained in the header section, and then reads the plural pieces of data in order. On the other hand, in special reproduction, the conventional audio reproduction apparatus reads the position information contained in the header section and the plural pieces of data alternately. In this case, examples of the special reproduction include fast-forward reproduction and fast-reverse reproduction.

FIG. 1 is a flowchart showing a special reproduction process to be performed by the conventional audio reproduction apparatus. As a direction is given for a special reproduction process, the conventional audio reproduction apparatus reads data (position information) from a data attribute information subsection included in the header section (S101). The conventional audio reproduction apparatus then interprets the readout position information, so as to obtain the starting address of the target frame to be reproduced next (S102). The conventional audio reproduction apparatus then reproduces the target frame (S103). This procedure is repeated until the special reproduction process has completed (S104). Special reproduction such as fast-forward reproduction or fast-reverse reproduction is thus achieved. As a result, during a special reproduction process, the header section and the data section are alternately accessed again and again. This repetition is accompanied by seek operations done by a head for an optical pick-up or a magnetic disc.

### SUMMARY OF THE INVENTION

The conventional technology shown in FIG. 1, however, is disadvantageous in that significant degradation in special reproduction often occurs. Specifically, since a seek operation appears during intervals between the data reading from the header section (S101) and the target frame reproduction (S103), a silent section often occurs in the special reproduction process. The silent section occurrence is dependent on the recording medium storing an audio file, the file layout on a recording medium, file fragmentation, and the like. The silent section occurrence significantly degrades the quality of special reproduction.

Furthermore, Japanese Unexamined Patent Application Publication No. 2004-171067 proposes a technology of storing header section information in a memory as management information. The audio reproduction apparatus disclosed in Japanese Unexamined Patent Application Publication No. 2004-171067 reads management information from the memory during a special reproduction process, instead of reading data from the header section (S101). This significantly reduces the number of seek operations.

However, the size of the data attribute information subsection (position information) included in the header section varies according to the number of frames contained in the data section. Therefore, in order to support a stream having a large number of frames, a large memory region has to be prepared. The audio reproduction apparatus disclosed in Japanese Unexamined Patent Application Publication No. 2004-171067 is disadvantageous in that its memory cost tends to increase. In the case where the memory capacity is so small that the memory is insufficient for the header section information, a seek operation appears in the special reproduction process. As a result, a silent section occurs thereby degrading the quality of special reproduction.

It is an object of the present invention to provide an audio reproduction apparatus, an audio reproduction method, a program, and a data management method, which improve the quality of special reproduction, and which reduce the memory cost of the audio reproduction apparatus.

The audio reproduction apparatus which achieves the objective above is an audio reproduction apparatus which reproduces an audio file including a header section and a data section, the header section containing position information for each unitary data, the data section containing a plurality of unitary data, the audio reproduction apparatus including: a reception unit operable to receive a special reproduction direction, the direction being given to repeat the partial reproduction and the partial skip of the data contained in the audio file in order; a calculation unit operable to calculate addresses of the plural pieces of data to be partially reproduced, by reading and interpreting the header of the audio file, when the special reproduction direction is received; a storage unit operable to store a special reproduction table in a memory, the special reproduction table containing the calculated addresses, the special reproduction table not containing addresses of data to be skipped; and a special reproduction unit operable to perform the special reproduction based on the addresses stored in the special reproduction table, wherein said special reproduction unit is operable to start the special reproduction, after completion of the calculation to an end of the data section by said calculation unit when the special reproduction is fast-forward reproduction, and is operable to start the special reproduction after completion of the calculation to a starting point of the data section by said calculation unit when the special reproduction is fast-reverse reproduction.

According to this configuration, a special reproduction table suitable for special reproduction is created immediately before a special reproduction process is performed. This improves the quality of special reproduction. This also reduces the required memory size. Specifically, no seek operation of traveling between the header section and the data section appears during the special reproduction process, on the recording medium storing the audio file. Therefore, no waiting time is required during intervals between partial data reproduction procedures. This prevents a silent section from occurring. This also improves the quality of special reproduction. In addition, the special reproduction table contains only the addresses of the data section to be partially reproduced. This reduces the data amount, thereby eliminating the need for a large memory. This configuration is useful for cost reduction. This configuration is suitable for household electric appliances which have a less powerful CPU and a smaller memory, in comparison with a personal computer or the like.

Here, the audio reproduction apparatus according to one aspect of the present invention, in which the calculation unit may calculate an offset value from a starting position of the data section included in the audio file, as the address.

According to this configuration, each address is represented as an offset value, thereby reducing the data amount of the special reproduction table.

Here, the audio reproduction apparatus according to one aspect of the present invention, in which the special reproduction direction may include a first data amount and a second data amount, the first data amount indicating a size of the data to be partially reproduced, the second data amount indicating a size of the data to be skipped, and said calculation unit may calculate the address of each piece of the data to be partially reproduced, based on a sum of the first and second data amounts.

This configuration supports various speeds for special reproduction. The speed of a special reproduction process (for example, fast-forward reproduction) is decided according to the ratio between the first and second data amounts and their data sizes. This configuration thus supports various types of special reproduction.

Here, the audio reproduction apparatus according to one aspect of the invention, in which the header section of the audio file contains a piece of position information for each audio frame as unitary data, the data section of the audio file containing a plurality of audio frames, each of the first and second data amount is specified by the number of frames, and said calculation unit may calculate the offset address of the audio frame corresponding to each piece of the data to be partially reproduced.

According to this configuration, since the calculation unit calculates the address based on an audio frame as a unit, the load applied on the configuration is relatively light, thereby offering enhanced speed.

Here, the audio reproduction apparatus according to one aspect of the present invention, in which the header section of the audio file contains a piece of position information for each audio frame as unitary data, the data section of the audio file containing a plurality of audio frames, each of the first and second data amounts is specified by the number of sectors, the sector being one of a plurality of sectors contained in a recording medium storing the audio file, and said calculation unit may calculate an offset from an address of a starting sector corresponding to each piece of the data to be partially reproduced, up to the audio frame which comes immediately after the starting sector address, the offset being calculated as the address.

According to this configuration, since each of the first and second data amounts is specified by the number of sector, special reproduction can be performed irrespective of audio file format (audio frame size in particular).

Here, the audio reproduction apparatus according to one aspect of the present invention, in which the header section of the audio file contains a piece of position information for each audio frame as unitary data, the data section of the audio file containing a plurality of audio frames, each of the first and second data amount is specified by a duration, and said calculation unit may calculate an offset address of the audio frame corresponding to each point in time at which the data is to be partially reproduced.

According to this configuration, since each of the first and second data amounts is specified by a duration, special reproduction can be performed irrespective of audio file format (audio frame size in particular) and recording medium (sector size in particular).

Here, the audio reproduction apparatus according to one aspect of the present invention, in which the header section of the audio file contains a piece of position information for each audio frame as unitary data, the data section of the audio file containing a plurality of audio frames, each of the first and second data amounts is selected from a number of audio frames, a number of sectors contained in a recording medium storing the audio file, and time duration, in a case where each of the first and second data amount is specified by the number of audio frames, said calculation unit is operable to calculate the offset from an address of a starting sector corresponding to each piece of the data to be partially reproduced, up to the audio frame which comes immediately after the starting sector address, the offset being calculated as the address, in a case where each of the first and second data amount is specified by the number of sectors, said calculation unit may calculate an offset from the address of a starting sector corresponding to each piece of the data to be partially reproduced, up to the audio frame which comes immediately after the starting sector address, the offset being calculated as the address, and in a case where each of the first and second data amount is specified by the duration, said calculation unit may calculate an offset address of the audio frame corresponding to each point in time at which the data is to be partially reproduced.

This configuration flexibly supports various types of specification based on the first and second data amounts, thereby allowing the audio reproduction apparatus to cover various types of requirements.

Here, the audio reproduction apparatus according to one aspect of the present invention, in which said calculation unit may calculate an address of each piece of data to be partially reproduced at a position later than where reproduction is being performed, when the direction for special reproduction is received.

In the case where a user gives a direction for special reproduction in the middle of normal reproduction, this configuration is particularly effective in reducing the required memory size.

Here, the audio reproduction apparatus according to one aspect of the present invention, in which said calculation unit may calculate a starting address of each piece of data to be partially reproduced.

This configuration reduces the required memory size.

Here, the audio reproduction apparatus according to one aspect of the present invention, wherein said calculation unit may calculate an offset from the starting address of the data section, up to the starting address of each piece of data to be partially reproduced, the offset being calculated as the address.

This configuration reduces the bit length of each address, thereby reducing the required memory size.

The audio reproduction method, the data management method, and the program according to the present invention, have the same configuration and effects as the above.

### FURTHER INFORMATION ABOUT TECHNICAL BACKGROUND TO THIS APPLICATION

Japanese Patent application No. 2006-321767 filed on Nov., 29 2006 is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a flowchart showing a special reproduction process to be performed by a conventional audio reproduction apparatus;

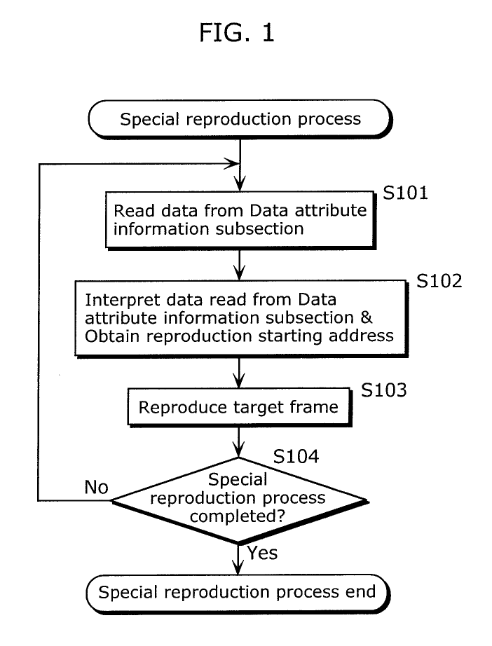

FIG. 2 is a block diagram showing the configuration of an audio reproduction apparatus according to an embodiment;

FIG. 3 is the brief format of an MPEG-4 AAC file;

FIG. 4 is a flowchart showing a special reproduction process according to the embodiment;

FIG. 5 illustrates a special reproduction table in the case of frame specification;

FIG. 6 is a flowchart showing a special reproduction table creation process in the case of frame specification;

FIG. 7 illustrates a special reproduction table in the case of sector specification;

FIG. 8 illustrates a special reproduction table in the case where a special reproduction process is started in the middle of normal reproduction;

FIG. 9 is a flowchart showing a special reproduction table creation process in the case of sector specification;

FIG. 10 is a flowchart showing a special reproduction table creation process in the case of time specification; and

FIG. 11 shows the configuration of an audio reproduction apparatus according to another embodiment.

### DESCRIPTION OF THE PREFERRED EMBODIMENT

Hereinafter, an embodiment of the present invention will be described with reference to the accompanying drawings.

The audio reproduction apparatus according to this embodiment, immediately before performing a special reproduction process, creates a management table suitable for the special reproduction process. This significantly reduces the number of seek operations which would appear in the special reproduction process. This configuration also reduces the memory cost of the audio reproduction apparatus.

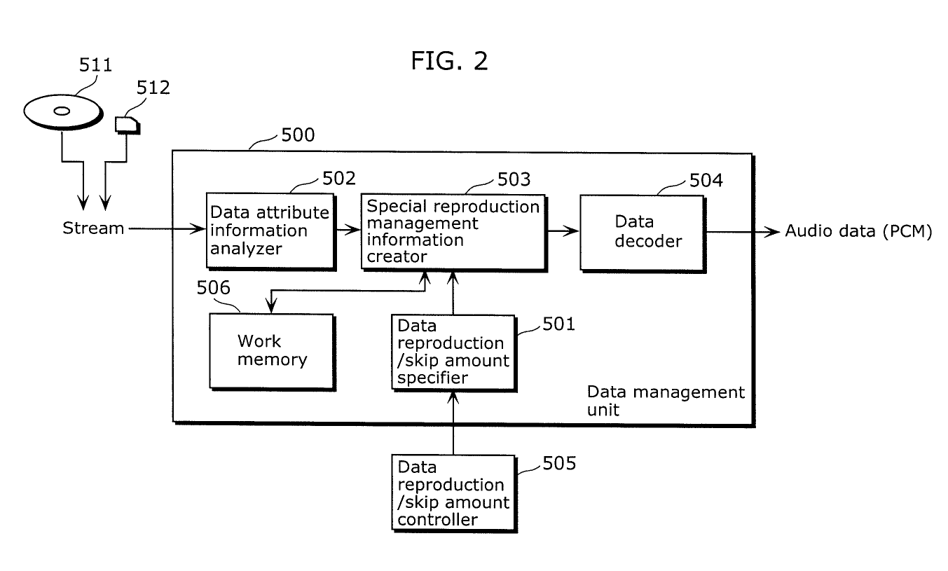

FIG. 2 is a block diagram showing the audio reproduction apparatus according to this embodiment. The audio reproduction apparatus reads an audio file from a disc 511 or a memory card 512, and then reproduces the audio file. The audio reproduction apparatus includes a data reproduction/skip amount controller 505 and a data management unit 500.

The disc 511 and the memory card 512 store an audio file. The audio file includes a header section which has position information for each piece of data. The audio file also includes a data section which has plural pieces of data. The audio file is a file encoded, for example, by MPEG-4 AAC (Moving Picture Experts Group-4 Advanced Audio Coding) format. The audio file is roughly divided into the header section and the data section. The data section contains plural pieces of unitary data (called an “audio frame” or simply a “frame”). The header section contains position information for each piece of unitary data.

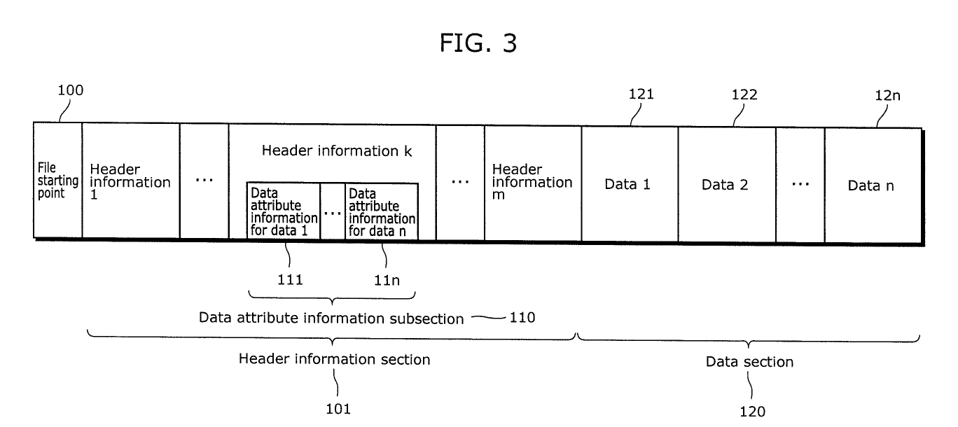

FIG. 3 is an exemplary format of the audio file. As shown in the figure, in the audio file, the following two sections come after a file starting point 100: a header information section 101 and a data section 120.

The header information section 101 contains one or plural pieces of header information (pieces of header information 1 to m). The pieces of header information 1 to m are m-number of kinds of individual pieces of header information. The header information indicates the following items: artist name, album name, song title, album jacket thumbnail image, and position information for each frame. In this embodiment, a piece of header information k (one included in the pieces of header information 1 to m) contains a data attribute information subsection 110 which has pieces of data attribute information 111 to 11n, respectively provided for pieces of data 1 to n, corresponding to an n-number of frames. The piece of attribute information 111 stores frame information for the first frame. The attribute information piece 11n stores frame information for the n-th frame as the last frame. In this case, the frame information contains attribute information (position information included) for audio frames.

The data section 120 includes the pieces of data 1 to n (121 to 12n). The data 1(121) contains the first frame data. The data n (12n) contains the n-th frame data.

The data reproduction/skip amount controller 505 indicates the following data amounts to the data management unit 500 in response to a direction given for special reproduction by a user: an amount of data to be partially reproduced (first data amount); and the amount of data to be skipped (second data amount). In this case, examples of the special reproduction include fast-forward reproduction, fast-reverse reproduction, and resume reproduction. Although this embodiment relates to fast-forward reproduction as a typical example, this embodiment is also applicable to other types of reproduction. The first and second data amounts are specified according to the following factors: (a) the number of sectors contained in the recording medium which stores the audio file; (b) the number of audio frames; and (c) time duration. Which factor is employed by the data reproduction/skip amount controller 505 may be determinately preset by the audio reproduction apparatus, or may be flexibly defined according to the user's direction or operational mode. By definition, the factor (a) is referred to as “sector specification”; the factor (b) as “frame specification”; and the factor (c) as “duration specification”.

The data management unit 500 includes a data reproduction/skip amount specifier 501; a data attribute information analyzer 502; a special reproduction management information creator 503; a data decoder 504; and a work memory 506.

As a direction is given for performing a special reproduction process, the data reproduction/skip amount specifier 501 receives the first and second data amounts specified by the data reproduction/skip amount controller 505. The data reproduction/skip amount specifier 501 then determines which factor specifies the first and second data amounts: (a) sector, (b) frame, or (c) time duration. The determination result and the first and second data amounts are notified to the special reproduction management information creator 503.

The data attribute information analyzer 502 analyzes the data attribute information subsection contained in the header information section of the audio file.

The special reproduction management information creator 503 includes a calculation unit for calculating the address of each piece of data to be partially reproduced in response to the direction given for the special reproduction process. The special reproduction management information creator 503 further includes the calculated addresses. The special reproduction management information creator 503 serves as a storage means for storing a special reproduction table, in the memory. The special reproduction table does not include the addresses of data to be skipped. Specifically, the special reproduction management information creator 503 creates the special reproduction table based on the following factors: the first and second data amounts specified by the data reproduction/skip amount specifier 501; the determination result that which one of the above (a) to (c) has been determined; and the result analyzed by the data attribute information analyzer 502. More specifically, the special reproduction management information creator 503 calculates the addresses of data to be partially reproduced, based on the first and second data amounts, and the analysis result of the data attribute information subsection contained in the header information section, in response to the direction given for performing special reproduction. Each of the addresses is represented, for example, as an offset value from the starting position of the data section contained in the audio file. The calculated addresses are stored in (added to) the special reproduction table stored in the work memory 506. Although addresses of data to be partially reproduced are added to the special reproduction table in order, the addresses of data to be skipped are not stored in the special reproduction table. This allows the size of the special reproduction table to be smaller.

The data decoder 504 performs the special reproduction process, based on the first and second data amounts and the addresses stored in the special reproduction table, after the completion of the special reproduction table creation. Specifically, the data decoder 504 reads and decodes the first data amount of data to be reproduced according to the addresses, so as to outputs the data as audio data (PCM data).

Next, a brief summary is given for a special reproduction process according to this embodiment.

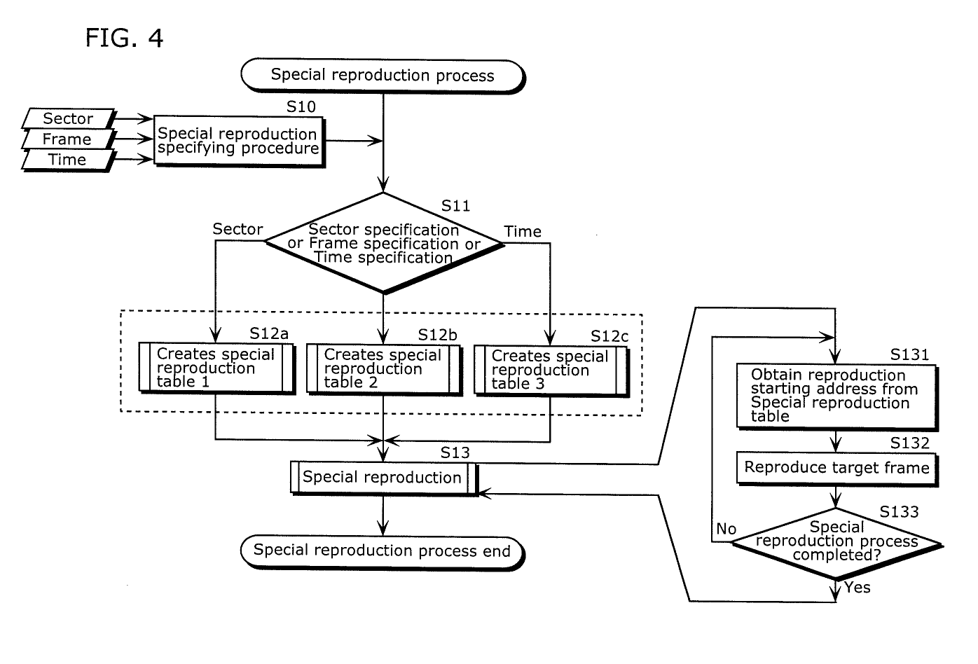

FIG. 4 is a flowchart briefly showing a special reproduction process according to this embodiment.

The special reproduction process shown in the figure starts when the user directs the audio reproduction apparatus to perform special reproduction.

In response to the direction given by the user for special reproduction, the data reproduction/skip amount controller 505 notifies a special reproduction direction indicating the first and second data amounts, to the data reproduction/skip amount specifier 501. This notification specifies the amount of data to be reproduced and the amount of data to be skipped, to the data reproduction/skip amount specifier 501. These values are specified as an external special reproduction specifying procedure (S10). As the unit for specification, one of the following is selected: (a) on a sector basis; (b) on a frame basis; (c) on a time basis; and others. The data reproduction/skip amount specifier 501 determines which one of the (a), (b) and (c) has been selected by the special reproduction direction. The data reproduction/skip amount specifier 501 then notifies the determination result to the special reproduction management information creator 503 (S11).

In response to the determination result among (a), (b), and (c), the special reproduction management information creator 503 creates a special reproduction table (S12a to S12c).

Hereinafter, a detailed description is given for a special reproduction table creation process in the special reproduction process according to this embodiment, for each of the cases (a) to (c).

First, a description is given for a special reproduction table creation process (b) when the first data amount is specified on a frame basis.

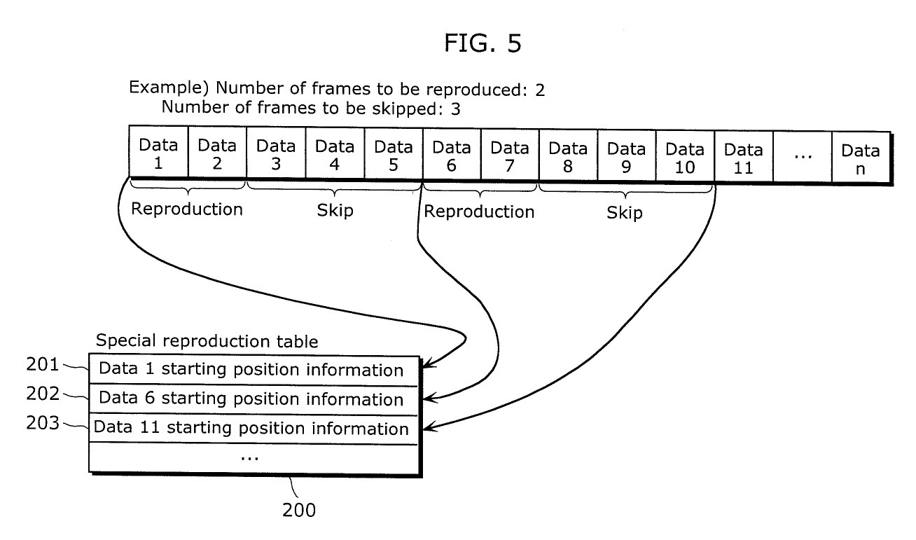

FIG. 5 illustrates a special reproduction table and an audio file in the case of frame specification. In this figure, a data section of the audio file and a special reproduction table 200 are shown, when the first data amount (number of frames to be reproduced) is two frames, and the second data amount (number of frames to be skipped) is three frames. Each of the pieces of data 1, 2 to n shows an audio frame. This example shows fast-forward reproduction. In the example, the following procedure is repeated in order for fast-forward reproduction: Two frames are reproduced. The next three frames are skipped. The next two frames are reproduced. The next three frames are skipped.

The special reproduction table 200 shown in the figure includes a piece of starting position information 201 of the data 1; a piece of starting position information 202 of the data 6; and a piece of starting position information 203 of the data 11.

In this example, the number of frames to be reproduced is defined as two frames, and the number of frames to be skipped as three frames. As fast-forward reproduction (FF) is directed, two frames are reproduced. The starting position information of the data 1 is stored at the top of the special reproduction table 200, as the starting position information 201 of the data 1. Since the subsequent three frames are to be skipped, the data to be reproduced next is the data 6. Therefore, the starting position information 202 of the data 6 is stored in the special reproduction table 200, in the field second to the top. The special reproduction table 200 is created by repeating this procedure. A special reproduction procedure is then started.

These pieces of starting position information are defined in order by the sum of the first data amount and the second data amount. For example, the starting position information 202 of the data 6 is the data 6's address. In this example, the data 6 is identified with the offset address from the starting point of the data section (the starting point of the data 1 in this figure). The pieces of starting position information are thus defined as their offset addresses. This reduces the bit length of each address, thereby minimizing the table size so as to reduce the required memory size.

Next, a description is given for the special reproduction procedure to be performed in this case. For fast-forward reproduction, a special reproduction procedure is performed after calculating all the pieces of starting position information of data to be reproduced through the end of the data section of the audio file. For fast-reverse reproduction, a special reproduction procedure is started after calculating all the pieces of starting position information of data to be reproduced through the starting point of the data section. As the procedure is started, as shown in FIG. 4, the starting position information 201 of the data 1 is read from the top of the special reproduction table 200 (S131). Based on the position information, its target frames are reproduced (S132). Since two frames are defined as the amount of data to be reproduced, the special reproduction table 200 is accessed again after reproducing the two frames. Next, the starting position information 202 of the data 6, stored in the table, is read so that its target frames are reproduced based on the position information. Fast-forward reproduction (FF) is thus performed by repeating the starting position information reading and its target frame reproduction (S133).

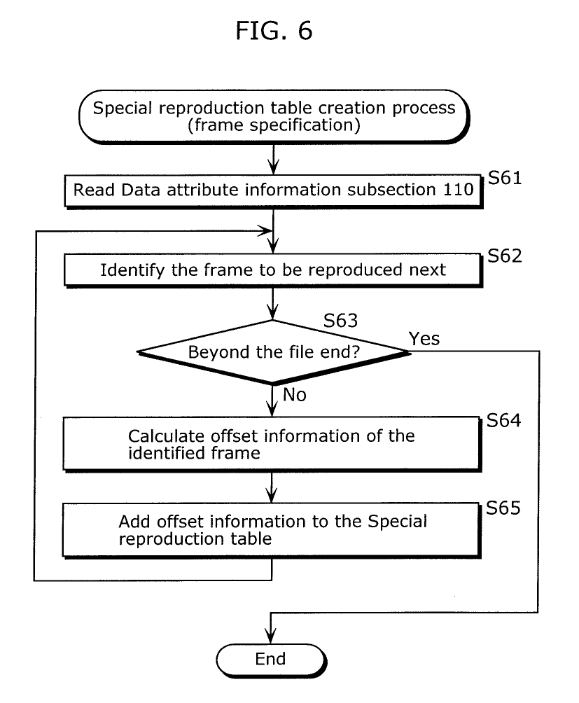

FIG. 6 is a flowchart showing a special reproduction table creation process (S12b in FIG. 4) in detail in the case of frame specification.

The data attribute information analyzer 502 reads and analyzes the data attribute information subsection 110 in the header information section of an audio file, so as to identify the position information of each frame (S61). Furthermore, the special reproduction management information creator 503 identifies the frames to be reproduced next based on the first and second data amounts (S62). When the identified frame is located not beyond the end of the data section (S63), the offset address of the identified frame is obtained by calculation (S64). The calculated offset address is added to the special reproduction table stored in the work memory 506 (S65).

On the other hand, when the identified frame is located beyond the end of the data section, the special reproduction table creation process is terminated (S63).

In the case of frame specification, the special reproduction management information creator 503 thus creates the special reproduction table shown in FIG. 5. In the case where the first and second data amounts are specified on a frame basis, since the special reproduction management information creator 503 calculates an address on an audio frame basis, the applied load is relatively light, thereby offering enhanced speed.

Note that the offset address mentioned in S64 indicates the offset from the position where reproduction is being performed at the point in time of the direction for special reproduction. In the case where no normal reproduction is being performed at the point in time of the direction for special reproduction, therefore, the offset address indicates an offset from the starting point of the data section as shown in FIG. 5.

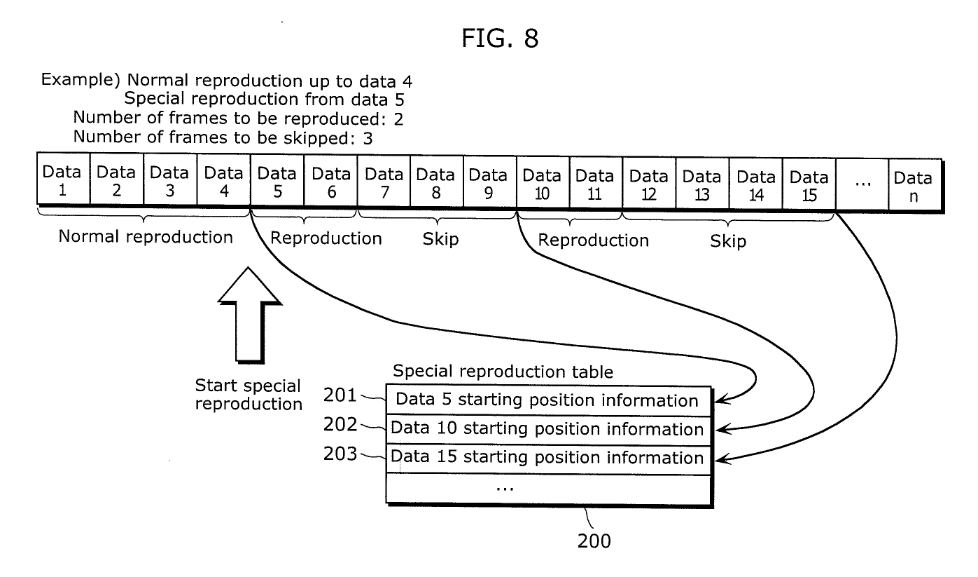

On the other hand, in the case where normal reproduction is being performed at the point in time of the direction for special reproduction, the offset address indicates an offset from the position where normal reproduction is performed. FIG. 8 illustrates a special reproduction table and an audio file in the case of frame specification. In FIG. 8, normal reproduction is performed from the starting point of a stream. A direction for special reproduction is given while the data 4 is being reproduced normally. In this case, the number of frames to be reproduced is defined as two frames, and the number of frames to be skipped as three frames. As fast-forward reproduction (FF) is directed, since the immediate two frames are to be reproduced, the starting position information 201 of the data 5 is stored at the top of the special reproduction table 200. Since the subsequent three frames are to be skipped, the data to be reproduced next is the data 10. Therefore, the starting position information 202 of the data 10 is stored in the special reproduction table 200, in the field second to the top. The special reproduction table 200 is created by repeating this procedure. A special reproduction procedure is then started.

In the special reproduction procedure shown in FIG. 8, the starting position information 201 of the data 5 is read as the starting point of the special reproduction table 200. Based on the position information, reproduction is performed. Since two frames are defined as the amount of data to be reproduced, the special reproduction table 200 is accessed again after reproducing the two frames. Next, the starting position information 202 of the data 10, stored in the table, is read so that its target frames are reproduced based on the position information. Fast-forward reproduction (FF) is thus performed by repeating the starting position information reading and its target frame reproduction.

In the case where a direction is given for special reproduction in the middle of normal reproduction, since the size of the special reproduction table is minimized, the required memory size can be reduced.

Next, a description is given for a special reproduction table creation process (a) when the first and second data amounts are specified on a sector basis.

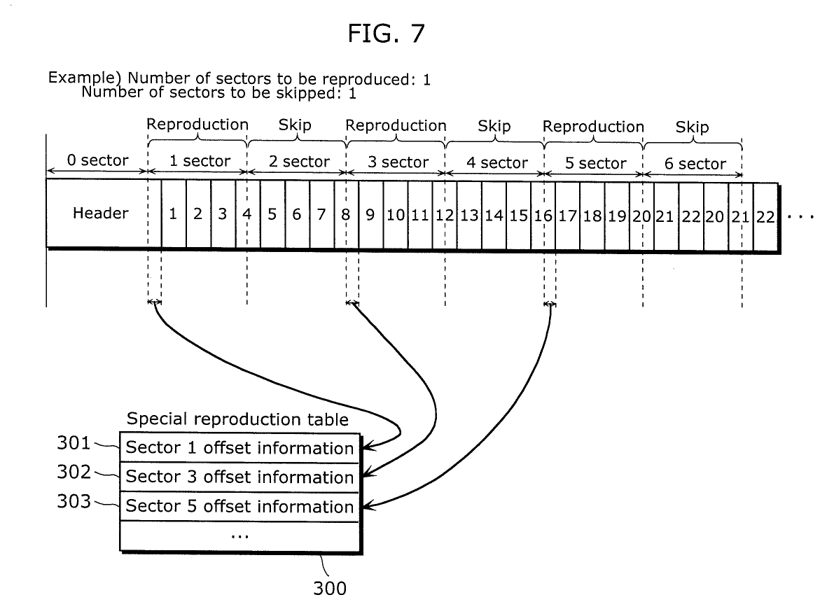

FIG. 7 illustrates a special reproduction table and an audio file in the case of sector specification. In this figure, a data section of the audio file and a special reproduction table 300 are shown, when the first data amount (number of sectors to be reproduced) is one sector, and the second data amount (number of sectors to be skipped) is also one sector. Each of the reference numbers 1, 2 . . . , 22 . . . in the figure indicates an audio frame. In the example, the following procedure is repeated in order for fast-forward reproduction: One sector is reproduced. The next one sector is skipped. The next one sector is reproduced. The next one sector is skipped.

The special reproduction table 300 shown in the figure includes a piece of offset information 301 of a sector 1; a piece of offset information 302 of a sector 3; a piece of offset information 303 of a sector 5 . . . . Each of the pieces of offset information indicates the offset from the starting address of the sector to be reproduced, up to the audio frame which comes immediately after the starting address.

Next, a description is given for a special reproduction procedure for the sector specification. In S131 shown in FIG. 4, the sector specification is different from the frame specification, in that the sector specification updates the starting addresses of the sectors to be reproduced in order, based on the number of sectors to be reproduced and the number of sectors to be skipped. The sector specification is also different from the frame specification, in that the sector specification adds the offset information 301 of the special reproduction table 300 to the updated starting address. For example, in the case where both the number of sectors to be reproduced and the number of sectors to be skipped are defined as one sector, as fast-forward reproduction (FF) is directed, the audio reproduction apparatus first tries to start reproduction from the sector 1 except the header information. However, it is from the first audio frame having its starting point within the sector, that the audio reproduction apparatus can start reproduction. Therefore, the offset information 301 stored at the top of the special reproduction table 300 is added to the starting address of the sector 1, so that the data 1 contained in the sector 1 is identified for reproduction.

Next, the sector 2 is skipped, and the sector 3 is reproduced. The offset information 302 stored in the special reproduction table 300 is also added to the starting address of the sector 3. This allows the data 9, or equivalently, the first frame having its starting point within the sector 3, to be identified for reproduction.

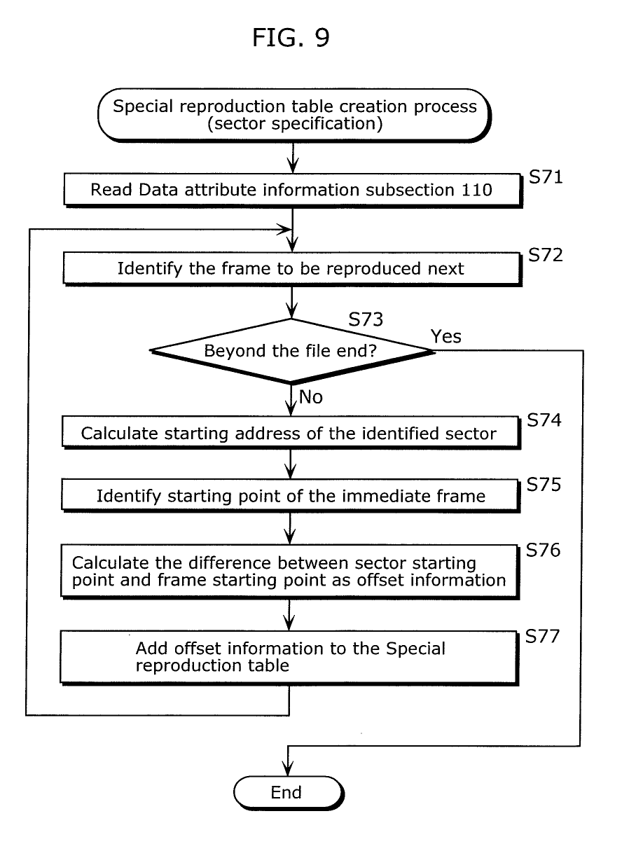

FIG. 9 is a flowchart showing a special reproduction table creation process (S12a in FIG. 4) in detail in the case of (a) sector specification.

The data attribute information analyzer 502 reads and analyzes the data attribute information subsection 110 in the header information section of an audio file, so as to identify the position information of each sector (S71). Furthermore, the special reproduction management information creator 503 identifies the sector to be reproduced next, based on the first and second data amounts (S72). When the identified sector is located not beyond the data section (S73), the starting address of the identified sector is obtained by calculation (S74). The starting point of the audio frame which comes immediately after the calculated starting address, is identified (S75). The difference between the calculated starting address and the identified starting point is obtained as offset information by calculation (S76). The obtained offset information is added to the special reproduction table 300 stored in the work memory 506 (S77).

On the other hand, when the identified sector is located beyond the end of the data section, the special reproduction table creation process is terminated (S73).

In the case of sector specification, the special reproduction management information creator 503 thus creates the special reproduction table 300 shown in FIG. 8.

Note that the offset information mentioned in S76 indicates the offset from the starting address of the sector to be reproduced, up to the sector which comes immediately after the starting address. This reduces the bit length of the offset information, in comparison with the case of the special reproduction table 200 for the frame specification, thereby further minimizing the size of the special reproduction table 300.

The offset information mentioned in S76 may be the offset from the position where reproduction is being performed at the point in time of the direction for special reproduction. In this case, the special reproduction table 300 has the same contents as in the special reproduction table 200.

As has been described above, in the case of sector specification, the special reproduction management information creator 503 can perform special reproduction irrespective of audio file format (audio frame size in particular).

Furthermore, a description is given for a special reproduction table creation process (c) when the first and second data amounts are specified on a time basis.

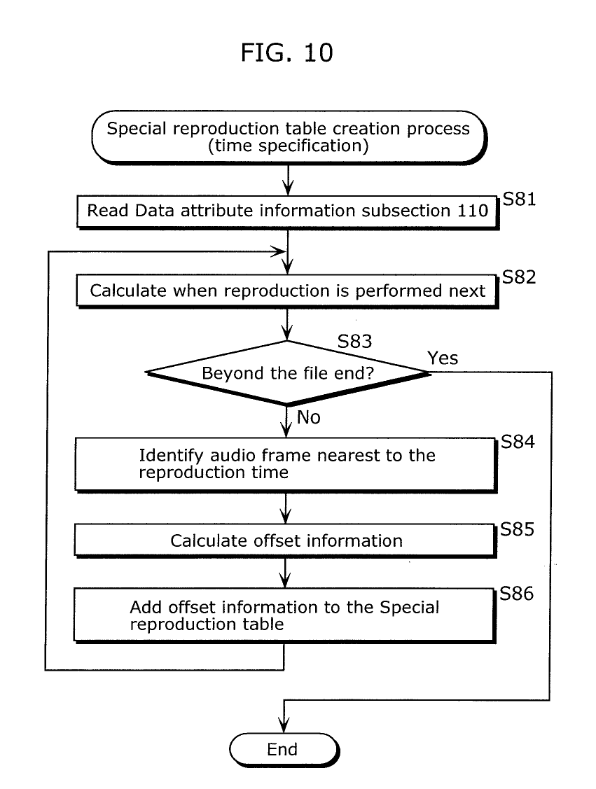

FIG. 10 is a flowchart showing a special reproduction table creation process (S12c in FIG. 4) in detail in the case of time specification.

The data attribute information analyzer 502 reads and analyzes the data attribute information subsection 110 in the header information section of an audio file, so as to identify the position information of each frame (S81). Furthermore, the special reproduction management information creator 503 identifies the time at which reproduction is to be performed next, based on the first and second data amounts (S82). When the identified time is located not beyond the end of the data section (S83), the starting point of the audio frame nearest to the identified time, is identified (S84). The offset information of the identified audio frame is obtained by calculation (S85). The obtained offset information is added to the special reproduction table stored in the work memory 506 (S86). The offset information for the time specification may be the offset from the position where reproduction is being performed at the point in time of the direction for special reproduction, similarly to the case of frame specification.

On the other hand, when the identified time is located beyond the end of the data section, the special reproduction table creation process is terminated (S83).

In the case of time specification, the special reproduction management information creator 503 thus creates the special reproduction table.

As has been described above, when each of the first and second data amounts is specified on a time basis, an accurate, flexible special reproduction procedure can be performed irrespective of audio file format (audio frame size in particular) and recording medium (sector size in particular).

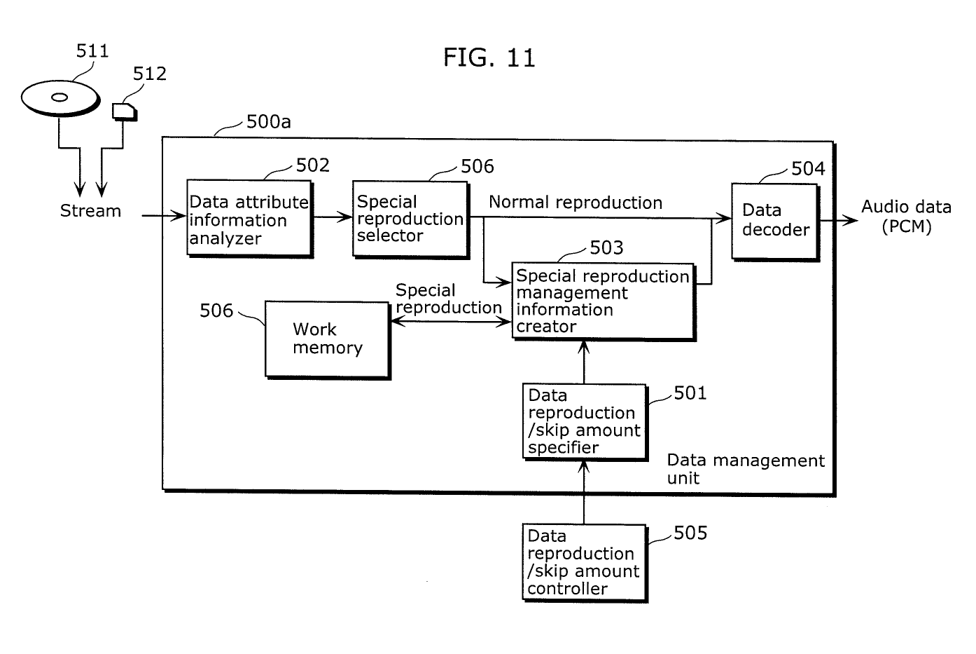

FIG. 11 shows an exemplary modification made to the audio reproduction apparatus. FIG. 11 is different from FIG. 2 in that the data management unit 500 further includes a special reproduction selector 506. In FIG. 11, the description for the structural points which are the same as in FIG. 2, is omitted, and only different points are described here.

As the stream read from an audio file is entered, the data attribute information analyzer 502 analyzes the data attribute information contained in the stream.

The special reproduction selector 506 determines which type of reproduction is to be performed: normal reproduction or special reproduction. In the case of normal reproduction, the analysis result and the data section of the audio file, are outputted to the data decoder 504 without change. In the cases of special reproduction, the special reproduction selector 506 outputs the analysis result to the special reproduction management information creator 503.

In the case where a direction is given for special reproduction in the middle of normal reproduction, the special reproduction selector 506 can output the analysis result and the data section, to the data decoder 504, without change, until the special reproduction management information creator 503 has completed the creation of the special reproduction table. This prevents a silent section from occurring during the time for switching from normal reproduction to special reproduction, in the case where a considerable amount of time is required for creating the special reproduction table.

This modification is useful, for example, in the case where the audio file size is large. This modification is also useful in the case where the CPU power utilized by the special reproduction management information creator 503 is low.

In the above embodiment, when no direction is given for special reproduction, the special reproduction table does not have to be created. In the reproductions other than special reproduction, the required memory region can be reduced, and the waiting time for reproduction start can be shortened. Furthermore, the special reproduction table contains only the position information of the data to be reproduced for special reproduction. The special reproduction table does not have to contain the position information of the data to be skipped. Therefore, the memory does not have to have a large storage area. In the case where the storage capacity equivalent to the memory included in a conventional audio reproduction apparatus is available, the number of re-accesses to the data attribute information subsection due to missing data attribute information, decreases, thereby achieving high-quality special reproduction with no silent section.

Although the above embodiment relates to fast-forward reproduction (FF), the above embodiment is also applicable to other special reproductions such as fast-reverse reproduction (FR) and resume reproduction.

Although the present invention relates to MPEG-4 AAC, any type of stream is applicable as long as the stream can have the same configuration. For example, WMA and Ogg are available.

The audio reproduction apparatus, the audio reproduction method, data management method, the program, and the program recording medium according to the present invention, achieve high-quality special reproduction for an audio stream compliant with MPEG-4 AAC and other audio streams having the same configuration. Therefore, the present invention is of great use to acoustic instruments capable of decoding, reproducing and special-reproducing such streams.

Each of the processes shown in the above flowcharts in this embodiment, is achieved through the program in which the processes are described, to be executed by a microcomputer. Therefore, the present invention is also applicable to such a program, as a matter of course. The present invention is yet also applicable to a computer-readable recording medium which stores such a program, as a matter of course.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An audio reproduction apparatus which reproduces an audio file including a header section and a data section, the header section containing position information for each unitary data, the data section containing a plurality of unitary data, said audio reproduction apparatus comprising:
a reception unit operable to receive a special reproduction direction, the direction being given to repeat the partial reproduction and the partial skip of the data contained in the audio file in order;
a calculation unit operable to calculate addresses of the plural pieces of data to be partially reproduced, by reading and interpreting the header of the audio file, when the special reproduction direction is received;
a storage unit operable to store a special reproduction table in a memory, the special reproduction table containing the calculated addresses, the special reproduction table not containing addresses of data to be skipped; and
a special reproduction unit operable to perform the special reproduction based on the addresses stored in the special reproduction table,
wherein said special reproduction unit is operable to start the special reproduction, after completion of the calculation to an end of the data section by said calculation unit when the special reproduction is fast-forward reproduction, and is operable to start the special reproduction after completion of the calculation to a starting point of the data section by said calculation unit when the special reproduction is fast-reverse reproduction.

2. The audio reproduction apparatus according to claim 1,
wherein said calculation unit is operable to calculate an offset value from a starting position of the data section included in the audio file, as the address.

3. The audio reproduction apparatus according to claim 1,
wherein the special reproduction direction includes a first data amount and a second data amount, the first data amount indicating a size of the data to be partially reproduced, the second data amount indicating a size of the data to be skipped, and
said calculation unit is operable to calculate the address of each piece of the data to be partially reproduced, based on a sum of the first and second data amounts.

4. The audio reproduction apparatus according to claim 3,
wherein the header section of the audio file contains a piece of position information for each audio frame as unitary data, the data section of the audio file containing a plurality of audio frames,
each of the first and second data amount is specified by the number of frames, and
said calculation unit is operable to calculate the offset address of the audio frame corresponding to each piece of the data to be partially reproduced.

5. The audio reproduction apparatus according to claim 3,
wherein the header section of the audio file contains a piece of position information for each audio frame as unitary data, the data section of the audio file containing a plurality of audio frames,
each of the first and second data amounts is specified by the number of sectors, the sector being one of a plurality of sectors contained in a recording medium storing the audio file, and
said calculation unit is operable to calculate an offset from an address of a starting sector corresponding to each piece of the data to be partially reproduced, up to the audio frame which comes immediately after the starting sector address, the offset being calculated as the address.

6. The audio reproduction apparatus according to claim 3,
wherein the header section of the audio file contains a piece of position information for each audio frame as unitary data, the data section of the audio file containing a plurality of audio frames,
each of the first and second data amount is specified by a duration, and
said calculation unit is operable to calculate an offset address of the audio frame corresponding to each point in time at which the data is to be partially reproduced.

7. The audio reproduction apparatus according to claim 3,
wherein the header section of the audio file contains a piece of position information for each audio frame as unitary data, the data section of the audio file containing a plurality of audio frames,
each of the first and second data amounts is selected from a number of audio frames, a number of sectors contained in a recording medium storing the audio file, and time duration,
in a case where each of the first and second data amount is specified by the number of audio frames, said calculation unit is operable to calculate the offset from an address of a starting sector corresponding to each piece of the data to be partially reproduced, up to the audio frame which comes immediately after the starting sector address, the offset being calculated as the address,
in a case where each of the first and second data amount is specified by the number of sectors, said calculation unit is operable to calculate an offset from the address of a starting sector corresponding to each piece of the data to be partially reproduced, up to the audio frame which comes immediately after the starting sector address, the offset being calculated as the address, and
in a case where each of the first and second data amount is specified by the duration, said calculation unit is operable to calculate an offset address of the audio frame corresponding to each point in time at which the data is to be partially reproduced.

8. The audio reproduction apparatus according to claim 2,
wherein said calculation unit is operable to calculate an address of each piece of data to be partially reproduced at a position later than where reproduction is being performed, when the direction for special reproduction is received.

9. The audio reproduction apparatus according to claim 8,
wherein said calculation unit is operable to calculate a starting address of each piece of data to be partially reproduced.

10. The audio reproduction apparatus according to claim 9,
wherein said calculation unit is operable to calculate an offset from the starting address of the data section, up to the starting address of each piece of data to be partially reproduced, the offset being calculated as the address.

11. An audio reproduction method which reproduces an audio file including a header section and a data section, the header section containing position information for each unitary data, the data section containing a plurality of unitary data, said audio reproduction method comprising:
receiving a special reproduction direction, the direction being given to repeat the partial reproduction and the partial skip of the data contained in the audio file in order;
calculating addresses of the plural pieces of data to be partially reproduced, by reading and interpreting the header of the audio file, when the special reproduction direction is received;
storing a special reproduction table in a memory, the special reproduction table containing the calculated addresses, the special reproduction table not containing addresses of data to be skipped; and
performing the special reproduction based on the addresses stored in the special reproduction table,
wherein the special reproduction starts, after completion of the calculation to an end of the data section by said calculating when the special reproduction is fast-forward reproduction, and the special reproduction starts after completion of the calculation to a starting point of the data section by said calculating when the special reproduction is fast-reverse reproduction.

12. The audio reproduction method according to claim 11,
wherein, in said calculating, an offset value from a starting position of the data section included in the audio file is calculated as the address.

13. The audio reproduction method according to claim 11,
wherein the special reproduction direction includes a first data amount and a second data amount, the first data amount indicating a size of the data to be partially reproduced, the second data amount indicating a size of the data to be skipped, and
in said calculating, the address of each piece of the data to be partially reproduced is calculated, based on a sum of the first and second data amounts.

14. The audio reproduction method according to claim 13,
wherein the header section of the audio file contains a piece of position information for each audio frame as unitary data, the data section of the audio file containing a plurality of audio frames,
each of the first and second data amount is specified by the number of frames, and
in said calculating, the offset address of the audio frame corresponding to each piece of the data to be partially reproduced is calculated.

15. The audio reproduction method according to claim 13,
wherein the header section of the audio file contains a piece of position information for each audio frame as unitary data, the data section of the audio file containing a plurality of audio frames,
each of the first and second data amounts is specified by the number of sectors, the sector being one of a plurality of sectors contained in a recording medium storing the audio file, and
in said calculating, an offset from an address of a starting sector corresponding to each piece of the data to be partially reproduced, up to the audio frame which comes immediately after the starting sector address is calculated as the address.

16. The audio reproduction method according to claim 13,
wherein the header section of the audio file contains a piece of position information for each audio frame as unitary data, the data section of the audio file containing a plurality of audio frames,
each of the first and second data amount is specified by a duration, and
in said calculating an offset address of the audio frame corresponding to each point in time at which the data is to be partially reproduced is calculated.

17. The audio reproduction method according to claim 13,
wherein the header section of the audio file contains a piece of position information for each audio frame as unitary data, the data section of the audio file containing a plurality of audio frames,
each of the first and second data amounts is selected from a number of audio frames, a number of sectors contained in a recording medium storing the audio file, and time duration,
in a case where each of the first and second data amount is specified by the number of audio frames, in said calculating, the offset from an address of a starting sector corresponding to each piece of the data to be partially reproduced is calculated, up to the audio frame which comes immediately after the starting sector address, the offset being calculated as the address,
in a case where each of the first and second data amount is specified by the number of sectors, in said calculating, an offset from the address of a starting sector corresponding to each piece of the data to be partially reproduced is calculated, up to the audio frame which comes immediately after the starting sector address, the offset being calculated as the address, and
in a case where each of the first and second data amount is specified by the duration, in said calculating, an offset address of the audio frame corresponding to each point in time at which the data is to be partially reproduced is calculated.

18. The audio reproduction method according to claim 12,
wherein in said calculating, an address of each piece of data to be partially reproduced at a position later than where reproduction is being performed, when the direction for special reproduction is received is calculated.

19. The audio reproduction method according to claim 18,
wherein in said calculating, a starting address of each piece of data to be partially reproduced is calculated.

20. The audio reproduction method according to claim 19,
wherein in said calculating, an offset from the starting address of the data section, up to the starting address of each piece of data to be partially reproduced is calculated, the offset being calculated as the address.

21. A data management method for reproducing an audio file including a header section and a data section, the header section containing position information for each unitary data, the data section containing a plurality of unitary data, said data management method comprising:
receiving a special reproduction direction, the direction being given to repeat the partial reproduction and the partial skip of the data contained in the audio file in order;
calculating addresses of the plural pieces of data to be partially reproduced, by reading and interpreting the header of the audio file, when the special reproduction direction is received; and
storing a special reproduction table in a memory, the special reproduction table containing the calculated addresses, the special reproduction table not containing addresses of data to be skipped.

22. A computer-readable program for reproducing an audio file including a header section and a data section, the header section containing position information for each unitary data, the data section containing a plurality of unitary data, said program causing a computer to execute:
receiving a special reproduction direction, the direction being given to repeat the partial reproduction and the partial skip of the data contained in the audio file in order;
calculating addresses of the plural pieces of data to be partially reproduced, by reading and interpreting the header of the audio file, when the special reproduction direction is received;
storing a special reproduction table in a memory, the special reproduction table containing the calculated addresses, the special reproduction table not containing addresses of data to be skipped; and
performing the special reproduction based on the addresses stored in the special reproduction table,
wherein the special reproduction unit is started, after completion of the calculation to an end of the data section by said calculation unit when the special reproduction is fast-forward reproduction, and the special reproduction is started after completion of the calculation to a starting point of the data section by said calculation unit when the special reproduction is fast-reverse reproduction.
